(19) United States
(12) Patent Application Publication
(10) Pub. No.: US 2024/0349157 A1
(43) Pub. Date: Oct. 17, 2024

(54) Switching a Communication Connection

(71) Applicant: Bayerische Motoren Werke Aktiengesellschaft, Muenchen (DE)

(72) Inventors: Walter BRONZI, Mountain View, CA (US); Albrecht NEFF, Sunnyvale, CA (US)

(21) Appl. No.: 18/631,466

(22) Filed: Apr. 10, 2024

(30) Foreign Application Priority Data
Apr. 11, 2023 (DE) 10 2023 109 117.4

(51) Int. Cl. H04W 36/32; G01C 21/34; G08G 1/00

(52) U.S. Cl. CPC H04W 36/322; G01C 21/3453; G08G 1/20

(57) ABSTRACT

A communication system includes a detector for detecting a geo-graphical region in which there is a need for communication; at least one motor vehicle having a first wireless interface for coupling to a mobile device in the area of the motor vehicle and a second wireless interface for coupling to a communication network; and a management device. The management device is designed to control the motor vehicle in order to make a communication connection in the determined region between a mobile device in the region and a resource connected to the communication network.

### CROSS REFERENCE TO RELATED APPLICATION

This application claims priority under 35 U.S.C. § 119 from German Patent Application No. 102023109117.4, filed Apr. 11, 2023, the entire disclosure of which is herein expressly incorporated by reference.

### BACKGROUND AND SUMMARY

The invention relates to the switching of a communication connection. In particular, the invention relates to the switching of a dynamic communication connection for a mobile device.

A mobile device, for example, a smartphone, a laptop computer or a tablet computer, comprises a wireless interface for connection to a communication network. As such, a connection to a communication network such as the Internet can be made by means of mobile radio, Bluetooth or WLAN, for example. The mobile device can then communicate with a resource connected to the communication network. The resource may comprise a server, a database or a service, for example.

In towns and cities, for example, coverage by such communication networks, or usable endpoints, is generally good, and so the mobile device can usually be used to access a desired resource directly. In certain regions, however, there may be only slow or incomplete coverage by suitable communication networks. Additionally, a connection quality may be reduced if many wireless devices attempt to communicate in a small space at the same time. An existing connection can break off or setup of a connection may be hampered.

A modern motor vehicle has a wireless communication connection to a predetermined communication network. By way of example, this connection can be used to send an automatic emergency call should the motor vehicle be involved in an accident, or usage or maintenance data can be transmitted to an analysis or maintenance service. A person aboard the motor vehicle can couple their mobile device to the motor vehicle in order to make joint use of the communication network.

A communication connection between a motor vehicle and a communication network generally cannot be used by a mobile device that is not associated with the motor vehicle, because the motor vehicle could move relative to the mobile device, with the result that the communication connection breaks off. Additionally, use of a communication network from the motor vehicle usually incurs costs, and so a billing model for use by an external mobile device would need to be produced. For reasons of data security or responsibility for transmitted content, for example, it may additionally be necessary to obtain a permit for use by a person associated with the motor vehicle.

An object on which the invention is based is an improved technique for switching a communication connection between a mobile device and a resource connected to a communication network. The invention achieves the object by means of the subjects of the independent claims. The dependent claims reproduce preferred embodiments.

According to a first aspect of the present invention, a communication system comprises a detector for detecting a geographical region in which there is a need for communication; at least one motor vehicle having a first wireless interface for coupling to a mobile device in the area of the motor vehicle and a second wireless interface for coupling to a communication network; and a management device. The management device is designed to control the motor vehicle in order to make a communication connection in the determined region between a mobile device in the region and a resource connected to the communication network.

In a simple embodiment, the management device may be aboard the motor vehicle, and so the motor vehicle can control the use of a communication connection if it determines that it is in a region in which there is an appropriate need. However, it is preferred for the management device to be provided outside the motor vehicle, in particular in the style of a central office, for example, as a server or as a service, for example, in a cloud. The use of the communication connection can be controlled on the basis of location, with the result that the motor vehicle cannot continue to share a connection if it moves out of the predetermined region.

The communication connection can be used by the mobile device to overcome low coverage or bandwidth. The mobile device can also use the communication connection at the same time as or in addition to another communication connection.

The management device may be designed to switch the communication connection for a mobile device that is not associated with the motor vehicle. The mobile device may be associated with a person who is outside the motor vehicle and who may also not be associated with the motor vehicle. In other words, the communication connection can be provided to any desired mobile device that is in the region and to which a wireless communication can be set up.

The motor vehicle may have an electric drive motor and an electrical energy store for the operation thereof. One of the wireless interfaces can be operated with energy from the energy store. The energy store for drive energy can facilitate intensive or sustained operation of the interfaces without this significantly limiting a mobility of the motor vehicle.

The motor vehicle can provide use of the communication connection while it is at a standstill and in particular while it is parked. However, the communication connection can also be used while a relative movement is taking place between the mobile device and the motor vehicle. A motor vehicle with a predetermined relative movement may be more suitable for a communication and can be given preference for a predetermined mobile device. In this case it can be accepted that the communication is possible only while the mobile device is in communication range.

The detector may be designed to determine a period of time relating to the need for communication. By way of example, a prediction can be made about the start, the progression and/or the end of a need for communication in the predetermined geographical region. The prediction can be determined on the basis of statistical methods, a planned occurrence such as a major event or an unplanned occurrence such as a natural disaster, for example.

The communication system may comprise a multiplicity of motor vehicles. A mobile device can make joint use of a communication connection of a motor vehicle that is favorably placed for communication purposes. Should a use be terminated, for example, because the motor vehicle moves away from the mobile device, a communication connection of another motor vehicle in the region can be used instead. The communication connection can be handed over transparently in this case. It is also possible for a mobile device to use communication connections of multiple motor vehicles at the same time.

The motor vehicle can be selected from the multiplicity of motor vehicles according to a predetermined heuristic. By way of example, this can be accomplished by taking into consideration whether a motor vehicle has a low energy status, a wireless communication connection is of low quality, or the motor vehicle is moving relative to the mobile device. In such cases, another motor vehicle may be sought that is better suited to providing the additional connectivity. Should the suitability of a selected motor vehicle deteriorate during the communication, another motor vehicle may be sought and the communication may be changed over.

The motor vehicles may have different equipment. By way of example, different motor vehicles can provide different first wireless interfaces for coupling to the mobile device, for example WLAN, Bluetooth, BT-LE, NFC or ZigBee. The motor vehicles may also have different second interfaces for connection to the communication network, for example via mobile radio, satellite radio, a further WLAN or a further motor vehicle, for example connected to a home WLAN.

Motor vehicles of the communication system may be designed to communicate with one another directly, for example, by means of C2C or C2I technology. A motor vehicle does not necessarily have to facilitate use of its first interface by a mobile device. By way of example, a motor vehicle may also operate as a forwarder that accepts messages from one motor vehicle and forwards them to another motor vehicle. If messages are forwarded to the communication network, the motor vehicle may operate as a router. Another motor vehicle may allow its first interface to be used by a mobile device, but may itself have no connection to a communication network. Such a motor vehicle may operate as an access point and communicate with one or more other motor vehicles.

The communication connection may extend at least between a first motor vehicle and a second motor vehicle. The communication connection may also extend via a chain of multiple motor vehicles. Such a chain can be configured dynamically, in particular on the basis of movements of the motor vehicles or the location of a node of the communication network that can be reached through the chain. A location or a determined or predicted movement of the mobile device that requires a communication connection can also be taken into consideration.

The communication system can control a communication connection in particular on the basis of a planned, observed, extrapolated or predicted movement of a motor vehicle and/or of the mobile device. In a further embodiment, the management device is designed to plan a journey by one of the motor vehicles of the communication system such that the motor vehicle is at least temporarily in the determined geographical region. By way of example, a planned journey by a motor vehicle can be altered such that the motor vehicle is traveling in the region. Preferably, a planned journey is altered only insofar as it results in no significant disadvantages for a transport or provision task of the motor vehicle. By way of example, an extension of the planned route or an extension of the planned journey time can be accepted only to a predetermined degree. A change may require consent from a person aboard the motor vehicle.

The motor vehicle can be autonomously steered into the determined geographical region. As such, a communication capacity in the geographical region can be increased in a specific way. In the process, it is possible to exploit the circumstance that an increased need for communication may be accompanied by increased need for mobility. As such, a fleet of motor vehicles can be put to another purpose.

The management device may be designed to control a distribution of communication connections over motor vehicles in the determined region. By way of example, it is possible to weigh up whether it is more advantageous to use only one of multiple motor vehicles that are in the region for the communication with mobile devices. This may be advantageous, for example, if it allows a bandwidth of the second interface to be exploited. The other motor vehicles are not able to get involved in a communication with mobile devices and to save electrical energy. In another scenario, communication connections in the region can be split over multiple motor vehicles. This allows a bottleneck in the data transmission to be avoided, for example.

The management device may further be designed to determine the geographical region on the basis of an indication of an event happening in the region. This allows fast and sometimes even predictive determination to take place. By way of example, it is possible to determine that a major sporting event or a concert is planned. If there are a lot of people in a region for the occasion, communication channels installed there may easily be overstretched. A present demand can be covered dynamically by using motor vehicles in the area of the event for communication in a specific way, as described herein. Additional installation of permanent resources for communication may not be necessary.

A similar approach may also be applied, for example, in the case of a disaster, such as in the event of a local power failure, a flood or an earthquake. This allows both private individuals and emergency workers to be provided with improved assistance.

According to another aspect of the present invention, a method for switching a communication connection comprises steps of detecting a geographical region in which there is a need for communication; and of controlling a motor vehicle having a first wireless interface for coupling to a mobile device in the area of the motor vehicle and a second wireless interface for coupling to a communication network in order to make a communication connection between a mobile device in the region and a resource connected to the communication network.

The method can be carried out by means of a communication system as described herein. To this end, the communication system may comprise an electronic management device that may comprise a programmable microcomputer or microcontroller. The method may be available in the form of a computer program product containing program code means. The computer program product may also be stored on a computer-readable data carrier. Features or advantages of the method can be applied to the communication system or vice versa.

In one embodiment, a movement of the motor vehicle with regard to the geographical region is controlled. This can be accomplished by altering a planned route of the motor vehicle and/or controlling the motor vehicle on a route. A route into the geographical region can be planned for a motor vehicle for which no movement was initially planned.

In yet another embodiment, movements of motor vehicles in the geographical region are determined. The movements may comprise planned and/or actual movements. A handover of the communication connection from one of the motor vehicles to another can then be controlled on the basis of the movements. As such, a mobile device in the geographical region can remain connected to the communication network even if a motor vehicle is not constantly in its vicinity.

The invention will now be described in more detail with reference to the accompanying drawings, in which:

### BRIEF DESCRIPTION OF THE DRAWINGS

FIG. 1 illustrates a communication system;

FIG. 2 illustrates a flowchart for a method; and

FIG. 3 illustrates a geographical region containing motor vehicles.

### DETAILED DESCRIPTION OF THE DRAWINGS

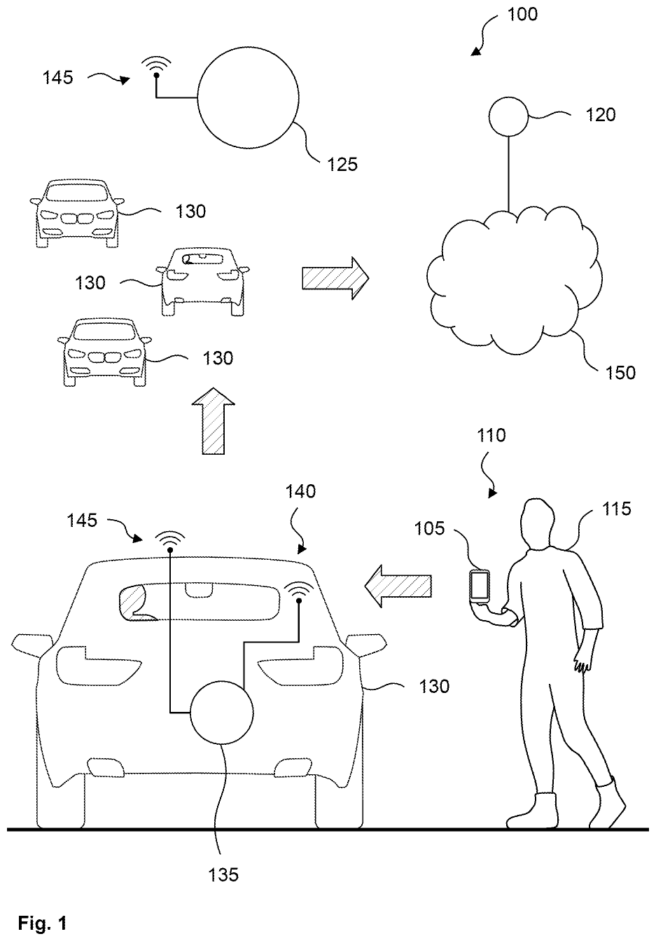

FIG. 1 shows a communication system 100 for providing a communication connection to a mobile device 105 that is in a geographical region 110 and can be used by a person 115. The mobile device 105 preferably comprises a smartphone, a laptop computer, a tablet computer or another device, which can be operated in particular wirelessly and in so doing conducts a communication with a remote resource 120. In one embodiment, another wirelessly networked device may also operate as the mobile device 105, for example, a networked motor vehicle. Normally, the mobile device 105 is permanently associated with the person 115.

The communication system 100 comprises a control apparatus 125, which is preferably embodied as a central component, for example, in the form of a server or a service, for example, in a cloud. Further, the communication system 100 comprises at least one, but preferably a multiplicity of, motor vehicle(s) 130. A motor vehicle 130 may be in the geographical region 110 or outside. In various scenarios, a motor vehicle 130 may be involved in the communication system 100 while it is parked or while it is traveling.

There is preferably provision aboard a motor vehicle 130 for a processing device 135 connected to at least one first wireless interface 140 and to at least one second interface 145. The first interface 140 is preferably provided for coupling to a mobile device 105 in the area of the motor vehicle 130 and may be implemented, for example, by means of WLAN or Bluetooth. A range of the first interface 140 is usually restricted to between a few meters and a few tens of meters on the basis of the technology used.

The second interface 145 is preferably designed for connection to a communication network 150 to which the mobile device 105 does not have access. By way of example, the communication network 150 may comprise a non-ground-based network such as a satellite network. The communication network 150 may also comprise a ground-based network, for example, a wireless network based on terrestrial radio stations. As a rule, the motor vehicle 130 is connected to the communication network 150 wirelessly in order to remain mobile. In another embodiment, the communication network 150 may facilitate a connection to the mobile device 105 from a technical point of view but prevent such a connection by way of an access restriction. As an example, the communication may be restricted to motor vehicles 105 of a predetermined manufacturer or operator of a vehicle fleet.

The control device 125 is preferably designed to use one of the interfaces 140, 145 to communicate with the motor vehicles 130. To this end, it may itself have a wireless interface 145. A communication with a motor vehicle 130 can take place directly or by way of the communication network 150.

It is proposed that a communication connection to a desired resource 120 be permitted, or switched, for a mobile device 105 by the communication network 150 under certain conditions. In this case, the mobile device 105 uses the first interface 140 to communicate with a motor vehicle 130 and the latter uses the second interface 145 either to communicate with the communication network 150, or a node provided for this purpose, directly or the connection first extends from the motor vehicle 130 to a further motor vehicle 130 and only from there to the communication network 150. Between the motor vehicles 130, the communication can take place by means of first interfaces 140 or second interfaces 145. In a further embodiment, a chain of more than two motor vehicles 130 can also be used for the communication between the mobile device 105 and the resource 120.

The use of one or more motor vehicles 105 for the communication between a mobile device 105 and a resource 120 is preferably restricted to the region 110. The region 110 can be determined by determining or predicting a need for communication in one or more mobile devices 105. It is accordingly also possible to determine a period of time during which the need for communication exists.

A communication between a mobile device 105 and a motor vehicle 130 is preferably controlled, or initiated, by means of a management device that, in different embodiments, may comprise a control device 125 and/or a processing device 135 aboard the motor vehicle 130. A processing device of the mobile device 105 may also have a part in the control and hence be regarded as a management device. The management device 125, 135 can be used or changed repeatedly during a communication. As such, a local management device 125 may initially be used in order to establish a communication between the mobile device 105 and a motor vehicle 130. Later, this communication connection may also be used to reach a remote management device 125 in order to continue to control the communication. The remote management device 125 may be in a cloud, for example.

In a first example, a mobile device 105 can display a need for communication to a motor vehicle 130, for example, directly or by means of broadcast via the first interface 140. The motor vehicle 130 can immediately take up the connection and provide a communication by way of the communication network 150. The communication may also be provided only after a sufficient number of requests for communication have been received from mobile devices 105. Multiple motor vehicles 105 in relative proximity to one another can exchange information with one another about requests that they each have in order to define the region 110. The motor vehicles 130 can also exchange information via communication paths through the network of motor vehicles in order to allow a motor vehicle 130 to reach a motor vehicle 130 with access to the communication system.

The definition can also be provided by the control device 125, which receives the applicable information from the motor vehicles 130.

In a second example, a motor vehicle 130 can indicate its readiness to forward communication data. A mobile device 105 can detect the readiness and use the offer of communication.

In a third example, the control device 125 can determine a region 110 on the basis of external information. By way of example, it can receive information about a disruption to another communication network and evaluate said information as an indication of a need for communication. Another piece of information that can indicate a need for communication relates to an extraordinary gathering of people 115, for example, on the occasion of a concert or a sporting event or in a traffic jam. It should be noted that a need for communication can also be determined predictively on the basis of such information and not just when requests for a communication by way of the communication network 150 arrive.

The control device 125 may be connected to any desired information sources in order to determine a region 110 having an increased need for communication. A determined region 110 has no predetermined maximum size. If required, multiple determined regions 110 may also be connected to one another to form a larger region 110. Conversely, a determined region 110 can also be split into multiple regions 110, or a region 110 can also be dispensed with. It is also possible to define whether the communication is possible only for specific target nodes 120 or specific services, e.g., only for emergency-related applications. As such, a communication for an emergency may be taken, but one for entertainment may be rejected. This decision may likewise be dependent on the location and/or a requested or applicable period of time.

It is preferred for the control device 125 to control the communication by one or more motor vehicles 130. This it can accomplish by evaluating information about planned routes of the motor vehicles 130. The taking of a communication connection from one motor vehicle 130 by another can be controlled centrally or locally. In one embodiment, a planned route of a motor vehicle 130 can be changed in order to take the motor vehicle 130 to a predetermined place in the region 110 or along a predetermined route in the region 110. Optionally, the motor vehicle 130 may also be autonomously steered to the place or along the route.

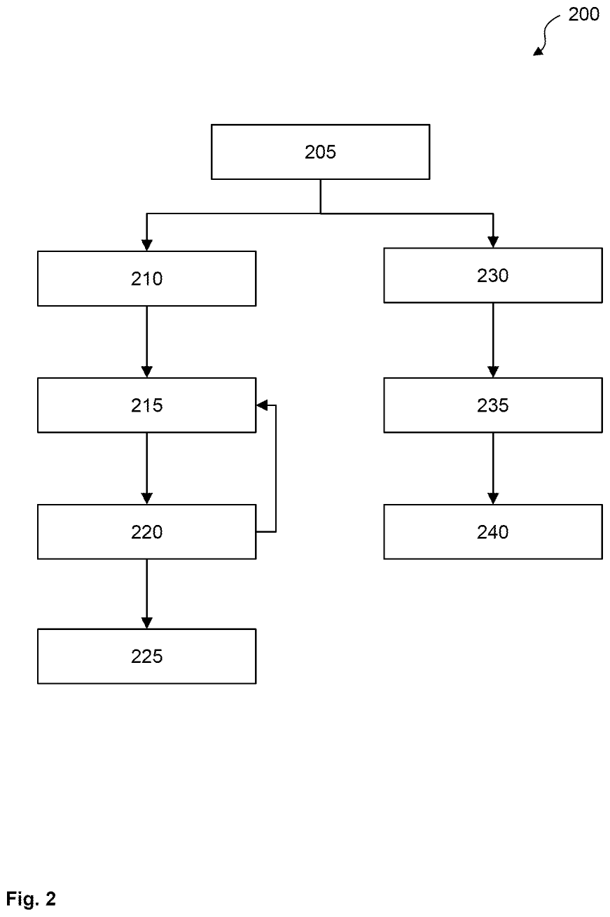

FIG. 2 shows a flowchart for a method 200 that can be carried out in particular by means of the system 100. In a step 205, a need for communication in one or more mobile devices 105 in physical proximity to one another can be determined. This can be taken as a basis for forming a region 110 in which there is a need for communication. It should be noted that this determination can take place on the basis of existing requests and/or predictively on the basis of information about gatherings of people 115.

In a step 210, positions of motor vehicles 130 eligible for a transmission of communication data can be determined. Motor vehicles 130 that are within the region 110 and optionally further motor vehicles 130 at a predetermined maximum distance from the region 110 are usually taken into consideration in this case.

In a step 215, a motor vehicle 130 available for a communication with a mobile device 105 that wants to communicate can be determined. The motor vehicle 130 may be at a standstill or moving. One or more parameters that can determine a suitability of a motor vehicle 130 can be taken into consideration for the selection.

By way of example, an energy status, a signal strength or a proximity of the motor vehicle to the mobile device can be taken into consideration. Energy consumptions of each of one or more of the motor vehicles can be optimized, for example by distributing a communication load fairly or giving preference to a motor vehicle that is connected to the power grid. Connectivity costs can be optimized. This can be accomplished by routing the communication to the motor vehicle that can provide a desired service most cheaply. As such, a motor vehicle with a 5G connection may be given preference over a vehicle with another mobile radio technology, for example.

A coverage per cost and per vehicle capacity can be optimized. A conflict with a nearby wireless network node can be taken into consideration. Neighboring areas around current locations of the motor vehicles can also be taken into consideration in accordance with a predicted path of movement of the mobile device.

A possible collision with another signal or a zone in which a connection is not permitted can be taken into consideration. A regionally prohibited communication frequency can be deactivated. A communication of a mobile device in an emergency situation can be prioritized. A movement of the motor vehicle with regard to the mobile device can likewise be taken as a basis for the selection. Preferably, a motor vehicle whose relative movement in relation to the mobile device is as small as possible is selected.

In a step 220, the motor vehicle 130 and the mobile device 105 can negotiate the circumstances under which the communication can take place. By way of example, a bandwidth, a communication period or a communication fee can be defined in this case. The type of a procured communication service or another type of use can be defined, in some cases according to the user or the scenario. Questions relating to data security or utilization control can also be clarified. Authentication between a motor vehicle 130 and a person with a mobile device 105 can be performed by means of an identification device in the motor vehicle 130. By way of example, the identification device may comprise a local identification or authentication mechanism for users, for example using a wireless protocol such as UWB or Bluetooth.

An authentication can take place in order to obtain a consent from a person associated with the motor vehicle 130 for the use of said motor vehicle as a communication component for the mobile device 105. A further authentication can take place between the mobile device 105 or its user and the motor vehicle 130. An authentication can take place in each case with the motor vehicle or with a service in the cloud or with both.

If the negotiation is not successful, it is possible to return to step 215 in order to select another eligible motor vehicle 130.

In a step 225, a connection between the mobile device 105 and a desired resource 120 can be switched, or controlled, by at least one motor vehicle 130 and the communication network 150.

Proceeding from step 205, a planned movement of motor vehicles 130 involved in the communication system 100 can be determined in a step 230. This can entail determining a motor vehicle 130 that is at a standstill in the region 110, a motor vehicle 130 that is entering the region 110, one that is being moved in the region 110, or one that is leaving the region 110.

This information can be taken as a basis for determining which motor vehicle 130 is available for a transmission of communication data at which time and at which place in the region 110.

Optionally, a planned movement of a motor vehicle 130 can be influenced in a step 235 in order to make an availability of the motor vehicle 130 in the region 110 more advantageous for the communication. As a further option, a motor vehicle 130 can also be controlled on the basis of the changed movement. The control can be provided by the motor vehicle 130 or by the control device 125.

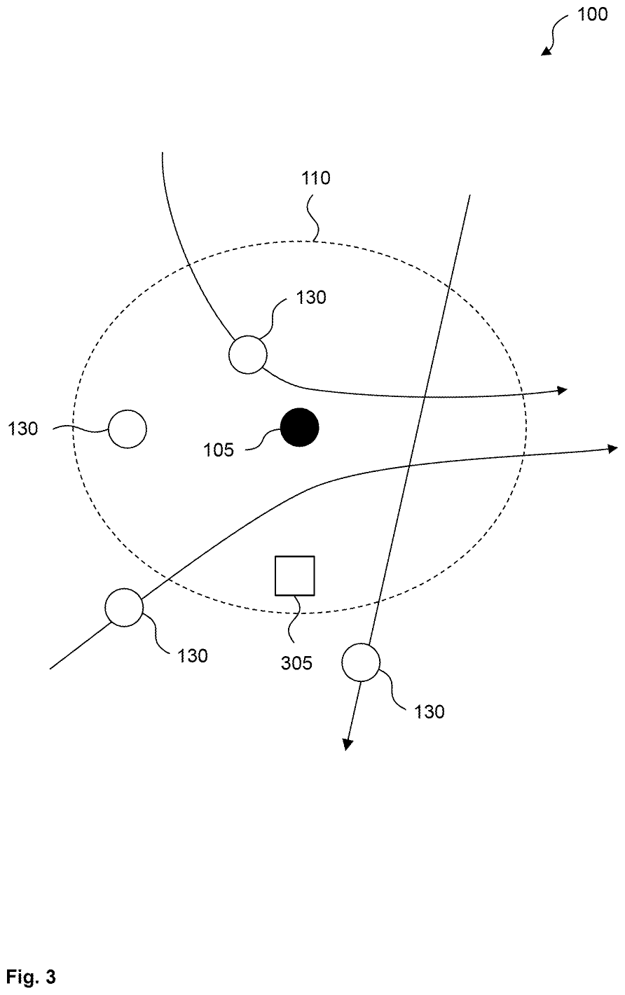

FIG. 3 shows an exemplary geographical region 110 containing exemplary motor vehicles 130 to illustrate a technique described herein. A mobile device 105 is depicted using a dark symbol and is in the middle of the region 110 for easier understanding. Light symbols are used to depict various motor vehicles 130. Moving motor vehicles 130 are depicted on associated trajectories, which are shown as arrows.

A first motor vehicle 130 depicted at the top has entered the region 110 and will also leave the region 110 again. In the meantime, the first motor vehicle 130 is available to forward communication data from or to the mobile device 105.

A second motor vehicle 130, depicted to the side of the mobile device 105, is at a standstill within the region 110 and can be continuously used for the communication.

A third motor vehicle 130, depicted at the bottom left, intends to enter the region 110. Furthermore, the plan is for the third motor vehicle 130 to also exit the region 110 again later. Between its entry and its exit, the third motor vehicle 130 can be used for the communication in the region 110.

A fourth motor vehicle 130, depicted at the bottom right, has already left the region 110 and is no longer available for a communication there. There is no plan to return to the region 110.

A communication between the mobile device 105 and a node 305 of the communication network 150 can be controlled on the basis of respective stays and lengths of stay of the motor vehicles 130. Further parameters can likewise be taken into consideration, for example a utilization of a motor vehicle 130 for communication, a connection quality or a fee charged for the communication.

### REFERENCE SIGNS

100 communication system
105 mobile device
110 region
115 person
120 resource
125 control apparatus
130 motor vehicle
135 processing device
140 first wireless interface
145 second wireless interface
150 communication network
200 method
205 determine region with need for communication
210 determine positions of motor vehicles
215 determine available motor vehicle
220 negotiate conditions
225 switch connection
230 determine planned movements of motor vehicles
235 influence planned movement of a motor vehicle
240 control motor vehicle
305 node

1. A communication system comprising:
a detector configured to detect a geographical region in which there is a need for communication;
a motor vehicle including a first wireless interface coupled to a mobile device in an area of the motor vehicle and a second wireless interface coupled to a communication network; and
a management device configured to control the motor vehicle in order to make a communication connection in the geographical region between a mobile device in the geographical region and a resource connected to the communication network.

2. The communication system according to claim 1, wherein the management device is configured to switch the communication connection for a mobile device that is not associated with the motor vehicle.

3. The communication system according to claim 2, wherein a relative movement takes place between the mobile device and the motor vehicle.

4. The communication system according to claim 1, wherein the detector is configured to determine a period of time relating to the need for communication.

5. The communication system according to claim 1, wherein a plurality of motor vehicles are included.

6. The communication system according to claim 5, wherein the motor vehicle is selected from the plurality of motor vehicles according to a predetermined heuristic.

7. The communication system according to claim 5, wherein the communication connection extends at least between a first motor vehicle and a second motor vehicle.

8. The communication system according to one of claim 5, wherein the management device is configured to plan a journey by one of the motor vehicles such that the motor vehicle is at least temporarily in the geographical region.

9. The communication system according to claim 8, wherein the motor vehicle is autonomously steered into the geographical region.

10. The communication system according to claim 5, wherein the management device is configured to control a distribution of communication connections over the motor vehicles in the geographical region.

11. The communication system according to claim 1, wherein the management device is configured to determine the geographical region based on an indication of an event happening in the geographical region.

12. A method for switching a communication connection, the method comprising:
detecting a geographical region in which there is a need for communication;
controlling a motor vehicle including a first wireless interface coupled to a mobile device in an area of the motor vehicle and a second wireless interface coupled to a communication network in order to make a communication connection between a mobile device in the geographical region and a resource connected to the communication network.

13. The method according to claim 12, wherein a movement of the motor vehicle with regard to the geographical region is controlled.

14. The method according to claim 12, wherein probable movements of motor vehicles in the geographical region are determined; and
wherein a handover of the communication connection from one of the motor vehicles to another is controlled.
